(19) United States
(12) Patent Application Publication
(10) Pub. No.: US 2018/0218626 A1
(43) Pub. Date: Aug. 2, 2018

(54) Method and System for Dynamically Optimized of Learning

(71) Applicant: National University of Singapore, Singapore (SG)

(72) Inventors: Brian O'Dwyer, Singapore (SG); Ranga Krishnan, Singapore (SG)

(21) Appl. No.: 15/748,054

(22) PCT Filed: Jul. 27, 2016
(86) PCT No.: PCT/SG2016/050353

§ 371 Date: Jan. 26, 2018

(30) Foreign Application Priority Data
Jul. 27, 2015 (SG) 10201505840U

(51) Int. Cl. G09B 7/04; G09B 7/08

(52) U.S. Cl. CPC G09B 7/04; G09B 7/08

(57) ABSTRACT

A method for dynamically optimized course of learning is provided. The method comprises creating a learning environment profile of target leaners of a target course, wherein the learning environment profile comprises one or more sets of data collected from the target leaners and one or more teachers of the target course; establishing a plurality of parameters for optimizing cerebral learning for the target leaners in response to the one or more sets of data; optimizing the course of learning in accordance with the plurality of parameters; presenting the optimized course of learning to one or more of the target learners; measuring the cerebral learning of the one or more target leaners of the optimized course or learning to arrive at an effectiveness feedback (EFK) of the plurality of parameters; and refining one or more of the plurality of parameters to dynamically optimize the course of learning when the effectiveness feedback falls below a predetermined threshold. Associated system is also provided.

### PRIORITY CLAIM

This application claims priority from Singapore Patent Application No. 10201505840U filed on 27 Jul. 2015.

### TECHNICAL FIELD OF DISCLOSURE

The following discloses method and system arrangements for dynamically optimized courses of learning.

### BACKGROUND

A number of scientific research studies exist which document and describe experiments of techniques and methods that improve learning. Also exist are a number of scientific research studies which describe techniques and frameworks to measure the effectiveness of learning. However, learning environments and even individual learner circumstances are oftentimes very unique. What may be highly effective in a laboratory under controlled settings or in a particular experiment in the field for a particular learner or a particular group of learners may not be translatable to different types of learners in different settings.

Thus, what is needed is a method and system for dynamically evolving courses of learning in accordance with various specific learning environments to optimize cerebral learning and learning effectiveness.

### SUMMARY

According to a first aspect of the present disclosure, there is provided a method for dynamically optimized course of learning, the method comprises creating a learning environment profile of target learners of a target course, wherein the learning environment profile comprises one or more sets of data collected from the target learners and one or more teachers of the target course; establishing a plurality of parameters for optimizing cerebral learning for the target learners in response to the one or more sets of data; optimizing the course of learning in accordance with the plurality of parameters; presenting the optimized course of learning on one or more of the target learners; measuring the cerebral learning of the one or more target learners of the optimized course of learning to arrive at an effectiveness feedback (EFK) of the plurality of parameters; and refining one or more of the plurality of parameters to dynamically optimize the course of learning when the effectiveness feedback falls below a predetermined threshold.

According to a second aspect of the present disclosure, there is provided a system for dynamically optimized course of learning. The system comprises at least one target learner and is configured to create a learning environment profile of target learners of a target course provided by an organization, wherein the learning environment profile comprises one or more sets of data collected from the target learners, the organization and one or more teachers of the target course; establish a plurality of parameters for optimizing a cerebral course of learning for the target learners in response to the one or more sets of data; optimize the course of learning in accordance with the plurality of parameters; present the optimized course of learning on one or more of the target learners; measure the cerebral learning of the one or more target learners of the optimized course of learning to arrive at an EFK of the plurality of parameters; and refine one or more of the plurality of parameters to dynamically optimize the course of learning when the effectiveness feedback falls below a predetermined threshold.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 shows a flowchart 100 depicting steps of a method for dynamically optimizing courses of learning.

FIG. 2 shows bar graphs 200 and 250 illustrating experimental results according to a first experiment of Example 2 of the dynamically optimized course of learning.

FIG. 3 shows a bar graph 300 illustrating experimental results according to a second experiment of Example 2 of the dynamically optimized course of learning.

FIG. 4 shows bar graphs 400 and 450 illustrating experimental results of Example 4 of the dynamically optimized course of learning.

FIG. 5 shows an exemplary system 200 for dynamically optimizing a course of learning.

### DETAILED DESCRIPTION

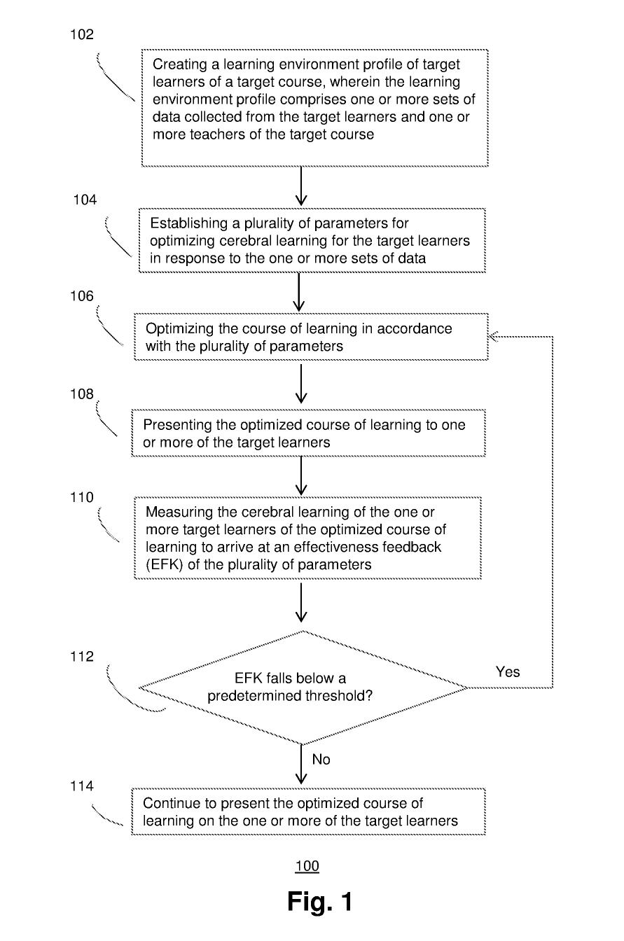

As illustrated in FIG. 1, flowchart 100 shows a method for dynamically optimizing a course of learning. The method comprises the following steps: creating 102 a learning environment profile of target learners of a target course, wherein the learning environment profile comprises one or more sets of data collected from the target learners and one or more teachers of the target course; establishing 104 a plurality of parameters for optimizing cerebral learning for the target learners in response to the one or more sets of data; optimizing 106 the course of learning in accordance with the plurality of parameters; presenting 108 the optimized course of learning on one or more of the target learners; measuring 110 the cerebral learning of the one or more target learners of the optimized course of learning to arrive at an EFK of the plurality of parameters; and refining 112 one or more of the plurality of parameters to dynamically optimize the course of learning if the EFK falls below a predetermined threshold. If the EFK falls above the predetermined threshold, then continue 114 to present the optimized course of learning on the one or more of the target learners or on additional ones of the one or more target learners.

In more detail, the disclosed method of the present application starts with a step of profiling a learning environment of target learners. In an embodiment, a series of questions is asked to form learning environment profiles for the target learners. The series of questions is designed to focus on a plurality of relevant elements involved in a target course of the target learners. For example, the relevant elements may comprise demographic information regarding learners, objectives, organization(s), teacher(s), and tools. It is understandable to the skilled person that one or more of these elements is used in creating the learning environment profiles.

In accordance with one aspect of the present embodiment, the following questions are asked to elicit demographic information on the target learners. These questions are for illustration purposes and should not be considered limiting. It is understandable to a skilled person in the art that there are other questions not illustrated herein that can also be used as profiling questions:

| Element | Profilling questions (include, but are not limited to) |
|---|---|
| Learner | 1. What is the learner's age? |
| | 2. What is the learner's education background? |
| | 3. What is the learner's socio-economic background? |
| | 4. What is the learner's parent's education and socio- |
| | economic background? |
| | 5. What is the learner's level of experience in the |
| | subject area of the target course? |
| | 6. How much time does the learner have to devote to |
| | learning the subject area of the target course? For |
| | example, in class environment and out of class |
| | environment? |
| | 7. What is the time profile of the learner's time for |
| | learning? For example, is it 100% for a year, 8 hours |
| | at one time, or 15 minutes per day? |
| | 8. What are the learner's objectives for the subject area |
| | of the target course? For example, for satisfaction |
| | with the learning, for the knowledge learnt from the |
| | target course, for changed behaviour, or for |
| | professional or other outcomes? |
| | 9. What does success look like for the learner? |
| | 10. What is the level of motivation for this learner in the |
| | subject area of the target course? |
| | 11. What are the learner's other learning commitments |
| | and objectives? |
| | 12. What are the learner's day-to-day professional tasks? |
| | How is the learner measured on these tasks? |
| | 13. Where is the learner located? |
| | 14. What is the learner's “learning style”? |

In the present embodiment, the following questions are asked to elicit demographic information on the objectives. These questions are for illustration purposes and should not be considered limiting. It is understandable to a skilled person in the art that there are other questions not illustrated herein can also be used as profiling questions:

| Element | Profiling questions (include, but are not limited to) |
|---|---|
| Objectives | 1. What is the objective of the learning? |
| | 2. What is the learner expected to be able to do after |
| | the learning? |

In the present embodiment, the following questions are asked to elicit further demographic information on the organizations and their learning goals. These questions are for illustration purposes and should not be considered limiting. It is understandable to a skilled person in the art that there are other questions not illustrated herein can also be used as profiling questions:

| Element | Profiling questions (include, but are not limited to) |
|---|---|
| Organization: | 1. What are the organizational objectives for the |
| | learning? For example, for the satisfaction with the |
| | learning, for the knowledge captured in the target course, |
| | for changed behaviour facilitated by the target course, or |
| | for professional or other outcomes that the target course |
| | may offer? |
| | 2. What are the organization's criteria for assessing |
| | success? ? |
| | 3. What resources are available to support the learning? |
| | For example, the resources may include time, financial |
| | support, people, process, systems and technology |
| | available for the target course. |

In the present embodiment, the following questions are asked regarding the teacher's objectives. These questions are for illustration purposes and should not be considered limiting. It is understandable to a skilled person in the art that there are other questions not illustrated herein can also be used as profiling questions:

| Element | Profiling questions (include, but are not limited to) |
|---|---|
| Teacher | 1. What are the teacher's objectives? |
| | 2. How much of the teacher's time is spent teaching? |
| | 3. Do the teachers have a background or formal |
| | instruction in teaching? |
| | 4. Have the teachers taught the content of the target |
| | course or other content before? |
| | 5. How well do the teachers know the content? How |
| | effective are they as a facilitator? Will the teachers be |
| | physically present with the learners? |

In the present embodiment, the following questions are asked concerning the tools available for the target course. These questions are for illustration purposes and should not be considered limiting. It is understandable to a skilled person in the art that there are other questions not illustrated herein can also be used as profiling questions:

| Element | Profiling questions (include, but are not limited to) |
|---|---|
| Tools | 1. What tools are available to support learning? The |
| | tools may include technology devices, internet access, |
| | and physical spaces. |

The responses to the questions on each of the above Elements are referred to herein as sets of data.

After the learning environment profiles of the target learners are created 102, a plurality of parameters for optimizing cerebral learning for the target learners are established 104 in response to the sets of data collected from answers of the above questions concerning one or more of the relevant elements. The plurality of parameters are also considered as ‘levers’ of the disclosed dynamically optimized course of learning. The plurality of parameters are described below. It is understandable to a skilled person in the art that there may be other levers that are not described herein but can also be used as relevant parameters, i.e. levers, to dynamically optimize the course of learning.

Amongst the plurality of parameters in the present embodiment, the first lever is goal setting. Motivation is an essential element to beginning and sustaining learning. It begins with being clear on what it is that the learners want to achieve. In other words, it's about setting goals. Starting a target course with the end in mind materially affects the learning result. The key word in goal setting is ‘mind’: visualizing and developing a concrete sense of the goal goes a long way to build motivation. All learning begins with a desire. A goal is the aim of an action that a person consciously desires to achieve. Therefore, goal setting is an important cognitive process affecting self-confidence and motivation.

Goals and plans to achieve those goals will lay a strong foundation for the learners' motivation for learning. Visualizing goals is, in fact, the initial path to motivation and learning. After all, a learner cannot get started if they do not know what they want to accomplish.

If the learners do not develop goals consciously and for themselves they risk becoming adrift and the goals are a result not of their desires but because of other causes: for example, a need for acceptance, parental desire, etc. Students who set a goal or work towards a goal set by others develop confidence when they hit that goal. It makes them more interested and motivated in persisting with their efforts to learn. They work harder and engage more to attain the next goal. This in turn promotes a positive cycle.

Amongst the plurality of parameters in the present embodiment, the second lever is self-organization to meet goals. Building the above described cycle with goals, motivation and performance requires self-discipline and self-organization. Having a goal is one thing but to meet goals and develop a sustainable learning cycle requires self-regulation. It requires planning, organization, and discipline to adhere to the path of the target learning.

Amongst the plurality of parameters in the present embodiment, an example of the third lever is the art of practice. Practice is conventionally recognized as a vital part of the learning process. But what is not fully recognized is that practice is not just doing the same thing over and over. The art of practice in the present embodiment focuses primarily on areas in which the learners are least competent and less in areas where the learners are already proficient.

Amongst the plurality of parameters in the present embodiment, an example of the fourth lever is the art of recall. Rereading of material is a form of recall. However, it is known that mere rereading of material is not as good as closing the book and then trying to remember what was learnt. Therefore, rereading material is not the art of recall preferred in the present embodiment. Testing is another form of recall. The testing effect refers to a boost in the long-term retention of information as a result of taking a test. Hence, testing is a preferred art of recall in accordance with the present embodiment. It is also understandable that testing may be a reinforcement step to practice.

Amongst the plurality of parameters in the present embodiment, an example of the fifth lever is spacing of learning. The following questions are considered in view of spacing of learning: How can the learners use repetition to their advantage? What is the most advantageous way to space their study sessions? Conventionally, the best time to re-read or repeat studying is when the learners have almost forgotten the subject. This lever can be applied according to different conditions of the learners with respect to when and how to repeat.

Amongst the plurality of parameters in the present embodiment, a sixth lever may be the art of mixing. In virtually every type of course or sport that the learners study or learn there are many topics and subtopics, be it a course on the heart or the nervous system, or English Grammar or calculus or a sport like baseball. Most of the learners study in a manner that firstly focuses on one topic; then, when they have completed that topic, they move to the next topic. It may seem that the best way to learn multiple topics is to study one topic thoroughly before moving to the next. The process appears natural and is one that the learners are accustomed to. However, this intuition is a fallacy. In accordance with the present embodiment, this sixth lever, the art of mixing, is introduced to mix up material the learners learn within and across subjects so as to enhance learning.

Amongst the plurality of parameters in the present embodiment, a seventh lever may be learning with friends. Generally, humans have always learned from each other and from their interaction with the world around them. Looking into daily experience, children pick up behaviours just by watching videos or cartoons and, conversely, reduce their inclination to imitate that behaviour if they see punishment for that behaviour. Even as adults, people learn constantly by their engagement with peers and other adults, even through links to the cyber world. In the present embodiment, this rule (learning with others/friends) can make the course of learning more productive and is considered as a valuable parameter in optimizing the course of learning.

Amongst the plurality of parameters in the present embodiment, an eighth lever may be the art of knowledge extension. In times past, the best medical students and those predicted to be successful would be those individuals who accumulated the most amount of factual knowledge that they could and then apply it in taking care of patients. This was equally true in most other fields of study. Today, however, the students are swamped by an ever-accumulating tsunami of information that is easily accessible but difficult to put in perspective. Information is at our fingertips; but how to apply it remains distant. The ease of reaching information has reduced the value of rote memorization of facts and increased the value of the ability to conceptualize, search, analyse, synthesize and apply knowledge. Learning today and for the future needs to move beyond memorization of facts to conceptual understanding and application in collaborative settings. Therefore, it is essential to build and extend knowledge by connecting to our cerebral storage of knowledge in the brain.

Amongst the plurality of parameters in the present embodiment, a ninth lever may be learning by living. Curiosity based exploration drives experience-dependent learning. This innate force that drives our learning gets squelched if not handled carefully. Therefore, it is valuable to keep it as a lever so as to keep it alive and, if it fades, rekindle it.

According to the data obtained from one or more of the questions answered in the learning environment profiling, the above plurality of parameters are established. Based on the plurality of parameters, the course of learning for the target learners can be optimized. In an embodiment, the course of learning for the target learners is optimized 106 by selecting a course of learning in accordance with the plurality of parameters from a set of predetermined courses of learning.

With reference to step 106, the optimization of a course of learning in accordance with the plurality of the above described parameters is further exemplified as follows. It is understandable to the skilled person in the art that the following questions are for illustration only and are not limiting:

| Lever (i.e. | |
|---|---|
| Parameter) | Optimization question and process |
| #1 - Goal | 1a) Are there effective goals of the learning program? |
| Setting: | If yes, proceed as planned. |
| | If no, set effective goals for the learning program before |
| | proceeding. |
| | 1b) Is the learner, teacher and organization aware of those |
| | goals? |
| | If yes, proceed as planned. |
| | If no, make the learner, teacher and organization aware of learning |
| | goals before proceeding. |
| | 1c) Are the goals SMART (specific, measurable, achievable, |
| | relevant and time bound)? |
| | If yes, proceed as planned. |
| | If no, modify the goals to be SMART |
| # 2 - Self- | 2) Are learners able to self-organize to meet all of the learning |
| Organization to | goals? |
| Meet Goals: | If yes, proceed as planned. |
| | If no, either modify the goals or provide support structures to make |
| | them able to self-organize. |
| | Note: there may be some circumstances where learners may be |
| | able to self-organize to meet certain goals but not others. This can |
| | be the case in open-ended application programs, where some |
| | learners may not know where to begin. In this circumstance, the |
| | learning goals can be broken down into small enough portions that |
| | learners are able to organize to meet the smaller scale learning |
| | goals. |
| # 3 - Art of | 3a) Is it feasible to design a practice system with adaptive |
| Practice: | feedback that allows learners to practise more the things they |
| | know less well, and practise less the things they know well? |
| | If yes, proceed with such a system. |
| | If no, then refer to question 3b. |
| | 3b) Is it feasible to design a practice system with non-adaptive |
| | feedback? |
| | If yes, proceed with such a system. |
| | If no, then proceed with a practice system even without feedback. |
| #4 - Art of | 4a) Is it feasible to design a system which requires learners to |
| Recall: | recall what they have learned without receiving cues (e.g. a |
| | free response test question)? |
| | If yes, proceed with such a system. |
| | If no, then refer to question 4b. |
| | 4b) Is it feasible to design a system which requires learners to |
| | recall what they have learned with receiving cues (e.g. a |
| | multiple choice test question)? |
| | If yes, proceed with such a system. |
| | If no, then proceed with a free recall system (e.g. have learners |
| | write down or reflect on what they have learned). |
| # 5 - Spacing | 5a) Is it feasible to space learning inside and outside of class, |
| Your Learning: | time, over a period of time? |
| | If yes, proceed with such a system. |
| | If no, then refer to question 5b. |
| | 5b) Is it feasible to space learning inside class time, over a |
| | period of time? |
| | If yes, proceed with such as system. |
| | If no, proceed with existing system, but consider spacing learning in the |
| | future. |
| #6 - Art of | 6) Is it feasible to mix or interleave the learning of various |
| Mixing: | subjects? |
| | If yes, proceed with such as system. |
| | If no, proceed with existing system, but consider interleaving |
| | learning in the future. |
| #7 - Learning | 7a) Is it feasible to create learning experiences in small groups |
| with Friends: | where learners are physically present in the same place? |
| | If yes, proceed with such a system. |
| | If no, then refer to question 7b. |
| | 7b) Is it feasible to create learning experiences in small groups |
| | where learners are virtually present in the same place? |
| | If yes, proceed with such a system. |
| | If no, proceed with existing system, but consider group learning in |
| | the future. |
| #8 - Art of | 8) Is it feasible to create learning experiences that involve the |
| Knowledge | application of learning (e.g. case studies and application |
| Extension: | cases)? |
| | If yes, proceed with such a system. |
| | If no, proceed with existing system, but consider application |
| | learning in the future. |
| # 9 - Learning | 9a) Do learners connect what they are learning with relevant |
| by Living: | situations that they are dealing with either now or in the future |
| | outside of the learning environment? |
| | If yes, proceed with such a system. |
| | If no, refer to question 9b. |
| | 9b) Is it feasible to connect what learners are learning with |
| | situations that are relevant for them? |
| | If yes, proceed with such a system. |
| | If no, proceed with existing system, but consider connecting with |
| | relevant situations in the future. |

As illustrated in FIG. 1, the course of learning optimized at step 106 is then presented 108 to the target learners. Effectiveness feedback (EFK) of the optimized course of learning is then assessed 110 by measuring the cerebral learning of the target learners. In the present invention, the measurement is designed to accommodate a plurality of aspects. For example, the measurement measures the target learners' reaction. In this instance, it may be necessary to evaluate the target learners' satisfaction and perception of the course of learning. In the case of a corporate sales program, the measurement could be results of an end-of-program feedback survey completed by the target learners. As another example, the measurement may focus on the retention of learning. In this instance, it may be necessary to evaluate the impact on the target learners' level of knowledge after a predetermined period of the course. In the case of a corporate sales program, the measurement could be the results of an assessment test or quiz completed by the target learners. As a further example, the measurement may measure behaviour changes of the target learners. In this instance, it may be necessary to evaluate the impact on the target learners' behaviours. In the case of a corporate sales program, the measurement could be an assessment by the target learners' manager of how the learners' behaviour has changed. For yet another example, the measurement may focus on outcomes. In this instance, it may be necessary to evaluate the impact on the target learners' performance. In the case of a corporate sales person, the measurement could include unit or dollar value of sales following the training program. For yet another example, the measurement may focus on return on investment. It may be necessary to evaluate the organization's return on investment. In the case of a corporate sales program, the measurement would compare the benefits of the program against the costs of the program. Amongst the above examples of measurement, one or more examples may be adopted. These examples are for illustration purposes only and should not be considered limiting. It is understandable to a skilled person in the art that there are other ways of measurement not illustrated herein which can also be used for determining EFK.

The following examples illustrate the application of the disclosed method of FIG. 1 on various groups of target learners under different circumstances.

Example 1: Target learners are well-educated and well-resourced graduate students in a medical program. In an existing method of teaching graduate students, each student is individually responsible for learning the core concepts and principles prior to coming to class, using learning materials made available to them by the faculty. This learning is reinforced by the Readiness Assurance Process (RAP) which includes Individual Readiness Assessment (IRA), usually given in the form of Multiple Choice Questions (MCQ), and followed by team assessments that is the Group Readiness Assessment (GRA) in which students repeat the same MCQs but answer as a team. The IRA/GRA MCQs are written to the level of difficulty such that the students as individuals obtain approximately 65-75% items correct. When these same problem sets are re-addressed as a team, they typically score 90-95% correct. The IRA process is designed to evaluate the student's understanding and retention of the core concepts and principles, but is not the end of the learning process. The GRA permits the students to learn from each other and as a team identify any gaps or uncertainties, which opens the students' minds for further learning. Both IRA and GRA assessments contribute to each student's individual final grade. After the RAP is completed, the students proceed through open-book/open Internet Application exercises which require critical analysis, problem solving and creativity and are all a part of their grade. The problem sets in this portion are addressed as a team and require the use of core content covered earlier (often directly linked to immediate RAP, but can be from earlier sessions as well). The team score for Applications generally runs between 75-85% correct.

All student teams meet in the same room and the entire class participates in discussions facilitated by a faculty member. Therefore, the learning goes from the individual student, to their team, to the entire classroom. This strategy does not require an individual faculty preceptor for each team. Instead, a faculty facilitator guides the learning for the entire class and may be assisted by several other faculty members, each with different content/subject expertise. They all work together to determine the key learning points and related preparatory content. Then, they co-develop MCQs and applications. Finally, the content experts provide clarity to core principles during class and a final summary of key points.

These sessions are generally delivered on average twice a week. Two hours are devoted to the RAP consisting of an average of 25 MCQs based on the prior preparation. (After a break, two to three hours are devoted to an application exercise which consists of a series of problem statements accompanied by several challenging evaluative questions.

The results of the existing method, as described above, can be improved by applying the method of the present invention as described below.

Based on this learning environment profile, the teachers and, optionally, the school, a plurality of parameters may be established as illustrated below. Then follows the optimization step 106 of the course of learning, which is also illustrated below.

| Lever (i.e. | |
|---|---|
| Parameter) | Optimization analysis |
| #1 - Goal | Yes. There is a very clear goal of completing a medical |
| Setting: | licensing exam. Therefore there is no need to modify existing |
| | goals. |
| # 2 - Self- | Yes. Medical students tend to be very highly motivated. |
| Organization to | Therefore there is no need to modify existing program. |
| Meet Goals: | |
| # 3 - Art of | Yes - to some extent. The system was designed with an |
| Practice: | individual test at the start of each class session. Note this is |
| | somewhat adaptive in the sense that difficult questions are |
| | repeated on later tests. |
| #4 - Art of | It was not feasible to develop a free response system because |
| Recall: | of the delay in giving feedback to learners. |
| | Instead, the aforementioned individual test system was |
| | developed, that required learners to select the correct answer |
| | from a list of possible choices |
| # 5 - Spacing | Yes. Learners were able to space learning outside of the |
| Your Learning: | classroom by watching pre-recorded video lectures prior to |
| | class time. |
| #6 - Art of | Yes - to some extent. The system was designed with a |
| Mixing: | comprehensive high stakes exam at the end in mind. As a |
| | result, all of the material is covered by the final exam and some |
| | individual class tests reference prior topics and material. |
| #7 - Learning | Yes. All of the learners are co-located and after the individual |
| with Friends: | test, complete the same test questions as a team. In addition, |
| | a part of the course involves applying the learning to specific |
| | case studies and this is also done in teams. |
| #8 - Art of | Yes. A part of the course involves applying the learning to |
| Knowledge | specific case studies and this is also done in teams. |
| Extension: | |
| # 9 - Learning by | Yes. Learners are aware of the upcoming licensing exams that make the |
| Living: | material they are learning relevant. |

It is understandable to the skilled person that in the above Example that the target learners are medical students who have relatively similar profiles in age, potential for success in medical school (as evidenced by the Medical College Admission Test scores) and education background (having minimum academic background of bachelor's degree). They are extremely highly motivated due to the intense selection process for medical school, and have nearly 100% of available professional time devoted to education for a period of four years. This Example is one context in which the present method may be applied. It is understandable to the skilled person that the present invention may be used for any learner with varying ages, potential for success and previous educational background and any level of learner motivation.

Example 2: Target learners are university level students at a cross-cultural institution.

In Example 2, the dynamic optimizing course of learning is aimed at improving active learning and making the content devised in one cultural context relevant to the students in another cultural context. In this learning environment, students review pre-readings and videos before class and then come to class to take an individual test to see how well they learned the material on their own. After this, students divide into teams and retake the same questions as a group to get immediate feedback on their ideas. After this, the class does a group debrief to identify points that need further study. This is followed by applying to learning the cases that are relevant in their cultural context.

Process:

| Lever (i.e. | |
|---|---|
| Parameter) | Optimization question and process |
| #1 - Goal | There were some goals for the learning program. However, some |
| Setting: | of them were not SMART. The existing goals were not allowed to be |
| | modified by the university. However, some additional goals were |
| | included. These additional goals were SMART. |
| # 2 - Self- | Yes - to some extent. Learners were able to organize to meet |
| Organization to | certain aspects of the course relatively easily. However, in other |
| Meet Goals: | aspects to the course it was more difficult. In these situations two |
| | things occurred. First, larger problems were broken down into |
| | several parts to make them more manageable. Second, learners |
| | were able to provide drafts (ungraded) to the professor for review before |
| | the final graded submission. |
| # 3 - Art of | Yes - to some extent. The system was designed with an individual |
| Practice: | test at the start of each class session. Note this is somewhat |
| | adaptive in the sense that difficult questions are repeated on later |
| | tests and addressed more fully in class time. |
| #4 - Art of | It was not feasible to develop a free response system because of |
| Recall: | the delay in giving feedback to learners. |
| | Instead the aforementioned individual test system was developed |
| | that required learners to select the correct answer from a list of |
| | possible choices |
| # 5 - Spacing | Yes. Learners were able to space learning outside of the classroom |
| Your Learning: | by completing pre-readings prior to class time. |
| #6 - Art of | Yes - to some extent. All of the material is covered by a |
| Mixing: | comprehensive final exam and some individual class tests will |
| | reference prior topics and material. |
| #7 - Learning | Yes. All of the learners are co-located and after the individual test, |
| with Friends: | complete the same test questions as a team. In addition, a part of |
| | the course involves applying the learning to specific case studies |
| | and this is also done in teams. |
| #8 - Art of | Yes. A part of the course involves applying the learning to |
| Knowledge | specific case studies and this is also done in teams. |
| Extension: | |
| # 9 - Learning | Not necessarily. As a result there was an emphasis on tying back |
| by Living: | key activities in the course to on-the-job skills. For example, a |
| | module on key performance indicators was explained to be relevant |
| | to students because they are the “grades” of the business world. |

In a first experiment of Example 2, the target learners comprise 17 fulltime undergraduate students on the Singapore campus of an American university. In this context, the dynamic optimizing course of learning aims at improving active learning and making the content devised in the U.S. cultural context relevant to the students in the Asian cultural context. Accordingly, the objectives of the dynamic optimizing course in this experiment comprise to improve outcomes with active learning techniques to deliver a regionally relevant curriculum in the “Management for Aeronautical Science” module, which is tailored to comprise 70% private pilot ground school classes with 30% aviation business 101 classes for the candidates in Bachelor of Science.

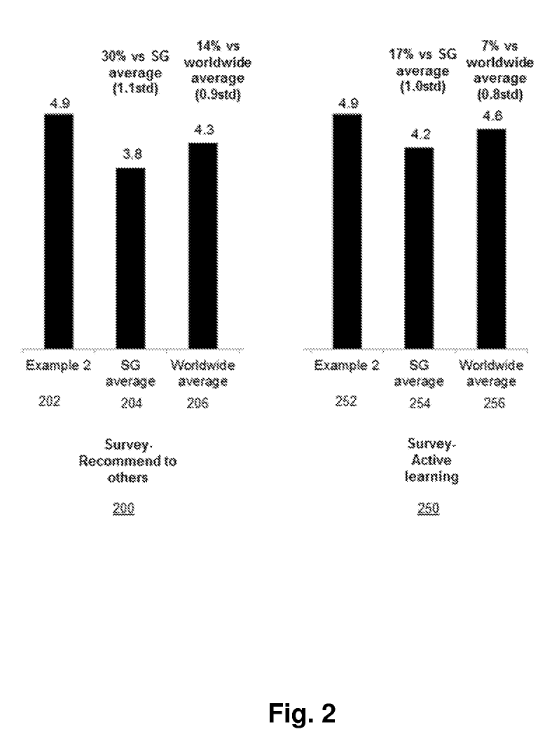

As an interim result of the first experiment of the optimized course of learning, after 9 weeks of the above optimized course, student surveys as illustrated in FIG. 2 show that the students on the Singapore campus of the American University have 30% higher likelihood of recommending the course than the usual Singapore university average (and 14% higher than the worldwide average). Stated differently, 98% of respondents would “recommend this course to others” compared to 75% for the usual Singapore university average (and 85% for the worldwide average). The surveys as illustrated in FIG. 2 for the optimized course of learning on the Singapore campus of the American university also present 17% higher active learning engagement than the Singapore university average (and 7% higher than the worldwide average).

In a second experiment of Example 2, target learners comprise 16 undergraduate students, master students and recent graduates from a region where English is not the first language, e.g. China. The objective of this experiment is to increase the target learner's knowledge and confidence in five core career skills, which include career strategy, pitching, networking, resume writing and interviewing. In this context, the optimized course of learning is designed to include pre-readings having 35 pre-recorded voice annotated lectures (all less than 10 minutes) distributed before a five-day boot camp style face-to-face session taught with team-based learning and simulations.

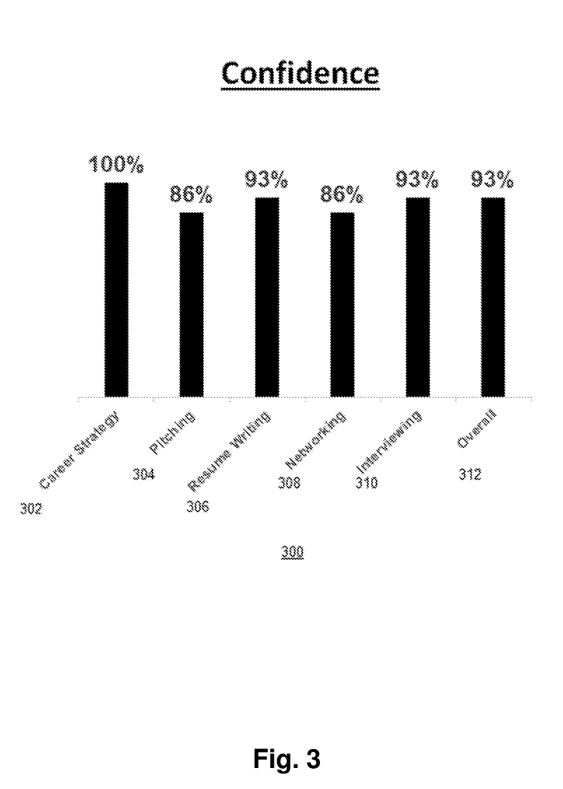

FIG. 3 shows a bar graph 300 illustrating the target learners' average confidence collected via a survey after the optimized course in the second experiment of Example 2. According to the survey, 94% of the target learners who have experienced the optimized course will recommend the course to other students. As shown in the bar graph 300, 100% of the target learners have indicated an increase of their confidence in career strategy; 86% of the target learners have indicated an increase of their confidence in pitching, 93% of the target learners have indicated an increase of their confidence in resume writing, 86% of the target learners have indicated an increase of their confidence in networking and 93% of the target learners have indicated an increase of their confidence in interviewing. Overall, 93% of the target learners have experienced an increase in their confidence after the optimized course of learning as described above.Example 3: Target learners are students at a primary school in resource deficient environment. The resource deficient environment may be an unestablished area in a developing region, e.g. rural Indonesia, or an unestablished area in a developed region, e.g. remote village in Australia.

The objective was to improve the educational delivery at a number of primary and secondary schools in resource deficient environment. Following site visits to several individual schools, learning program pilot focused on English as a second language instruction for first and second grade primary school children.

Process

| Lever (i.e. | |
|---|---|
| Parameter) | Optimization question and process |
| #1 - Goal | There were not goals that could be clearly explained by learners, |
| Setting: | teachers and administrators. As a result, the first task was to set |
| | clear measurable objectives for students and specify which words |
| | and phrases in English the learners were expected to learn and how they |
| | would be measured (e.g. hearing, speaking, reading or writing). |
| # 2 - Self- | Learners in this environment (children aged six and seven) from |
| Organization to | families with limited educational background were not prepared to |
| Meet Goals: | self-organize to meet goals. As a result the program was designed |
| | to take place mostly in the classroom under the support of a teacher |
| | and to focus on very short two to three minute segments of learning |
| | for a maximum of 15 minutes per day. |
| # 3 - Art of | Yes. An adaptive learning system with English was devised which |
| Practice: | would allow for testing frequently things learners did not know well |
| | and testing less frequently the things learners knew well. |
| #4 - Art of | Due to resource constraints it was not effective to design a free |
| Recall: | recall system, so a system of cued recall was devised instead |
| | wherein learners would select a correct answer from a list of |
| | choices. |
| # 5 - Spacing | No. It was not possible for learners to space learning outside of the |
| Your Learning: | classroom due to self-organization and technical and other resource |
| | constraints. As a result learning time was set at 5 sessions per |
| | week of 15 minutes (total 75 minutes) instead of one 80 minute |
| | session per week. |
| #6 - Art of | No. It was not feasible as this time due to the specific nature of |
| Mixing: | teaching English. It would have been difficult to incorporate for non- |
| | English speaking teachers to incorporate English into other subjects |
| | such as math or science. However, this was devised and may be |
| | pursued in the future. |
| #7 - Learning | Yes. All of the learners were co-located and team-based work in |
| with Friends: | small groups was devised. |
| #8 - Art of | Yes. The program included several forms of applying the English |
| Knowledge | words that were learned into games and activities such as singing |
| Extension: | songs with hand motions. |
| # 9 - Learning | Not necessarily. As a result there was an emphasis on making the |
| by Living: | words and phrases relevant for the learners by using objects that |
| | learners would encounter in their daily environment. In addition the |
| | teachers' ordinary vocabulary used on a given day was to be |
| | recorded and translated, and the English teaching then focused on |
| | the words most frequently used by teachers in the local language. |

Example 4: The target learners are corporate employees, e.g. commercial and medical leaders and managers. In an experiment of Example 4, a pharmaceutical company wants to improve the skills of its employees. Its employees had different backgrounds and levels of expertise. In the experiment, the target learners comprise 60 employees of the pharmaceutical company recruited from 10 Asian countries. The company wants its employees to learn about certain respiratory diseases and the company's products to treat those diseases. In the experiment, the objective is to increase the target learners' knowledge and confidence in this disease area. Learners completed pre-work (e.g. pre-readings) on their own, followed by a three day face-to-face session. The face-to-face session comprised a 1.5 day sales simulation session and a 1.5 day team-based learning.

Process

| Lever | Optimization question and process |
|---|---|
| #1 - Goal | Yes. As sales people, learners had very clear goals and goals did |
| Setting: | not need to be set. |
| # 2 - Self- | Yes. As sales people, learners were already able to self-organize to meet |
| Organize to Meet | goals |
| Goals | |
| # 3 - Art of | Yes to some extent. There were tests before and after each module |
| Practice: | and at the beginning of the program. They were not adaptive |
| | however. |
| # 4 - Art of | Due to resource constraints, it was not effective to design a free |
| Recall: | recall system so a system of cued recall was devised instead, |
| | wherein learners would select a correct answer from a list of |
| | choices. |
| # 5 - Spacing | Yes to some extent. The program was designed to have some pre- |
| Your Learning: | work in advance of a one-to-two day face-to-face session. |
| # 6 - Art of | Yes to some extent. A number of topics were covered in the pre- |
| Mixing: | work before the face-to-face session and again in the face-to-face |
| | session. |
| # 7 - Learning | Yes. For the face-to-face portion of the program, learners were co- |
| with Friends: | located and team-based work in small groups was undertaken.. |
| # 8 - Art of | Yes. The program included several application cases during the |
| Knowledge | face-to-face portion where learners practised applying what had |
| Extension: | been learned. |
| # 9 - Learning | Not applicable |
| by Living: | |

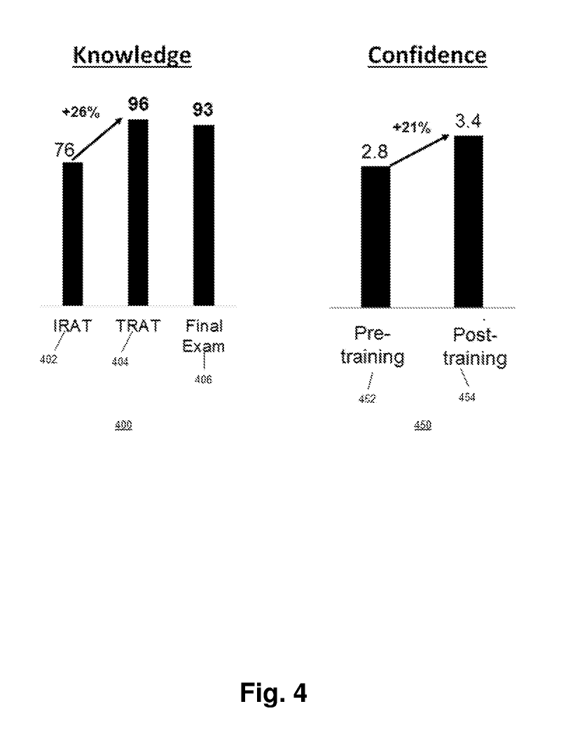

FIG. 4 shows experimental results of Example 4 in respect of knowledge and confidence improvements achieved by the optimized course of learning. FIG. 4 comprises bar graphs 400 and 450. In the bar graph 400, the initial average knowledge retention of the target learners before the optimized course is 76%. After the optimized course of learning, it can be seen from bar 404 that the average knowledge retention of the trained target learners has been significantly increased to 96% (26% higher than the initial stage). Using a final exam to assess the final knowledge retention, the average knowledge retention 406 remains at a high level of 93%. In the bar graph 450, the target learners have an average level of confidence at 2.8, as shown in bar 452, before the optimized course of learning. After the optimized course of learning, the average level of confidence is increased to 3.4, as shown in bar 454, being 21% higher than the average level of confidence before the course.

In view of the above, a summary of levers applied in various learning environments may be illustrated as follows:

| | Well- | | | |
|---|---|---|---|---|
| | educated, | | | |
| | well- | University | Youngsters | |
| | resourced | Students in | (aged | |
| | Graduate | cross- | 5-12) in | |
| | students in a | cultural | a resource | Corporate |
| Lever (i.e. | University | tertiary | deficient | Sales |
| Parameter) | program | institution | location | Force |
| #1 - Goal | Not Needed | Yes | Yes | Not Needed |
| Setting: | | | | |
| # 2 - Self- | Not Needed | Somewhat | Yes | Not Needed |
| Organization | | | | |
| to Meet Goals: | | | | |
| # 3 - Art of | Yes | Yes | Yes | Somewhat |
| Practice: | | | | |
| #4 - Art of | Yes | Yes | Yes | Yes |
| Recall: | | | | |
| # 5 - Spacing | Yes | Yes | Somewhat | Somewhat |
| Your | | | | |
| Learning: | | | | |
| #6 - Art of | Yes | Yes | Not | Yes |
| Mixing: | | | Possible | |
| #7 - Learning | Yes | Yes | Yes | Yes |
| with Friends: | | | | |
| #8 - Art of | Yes | Yes | Yes | Yes |
| Knowledge | | | | |
| Extension: | | | | |
| # 9 - Learning | Not Needed | Yes | Yes | Yes |
| by Living: | | | | |

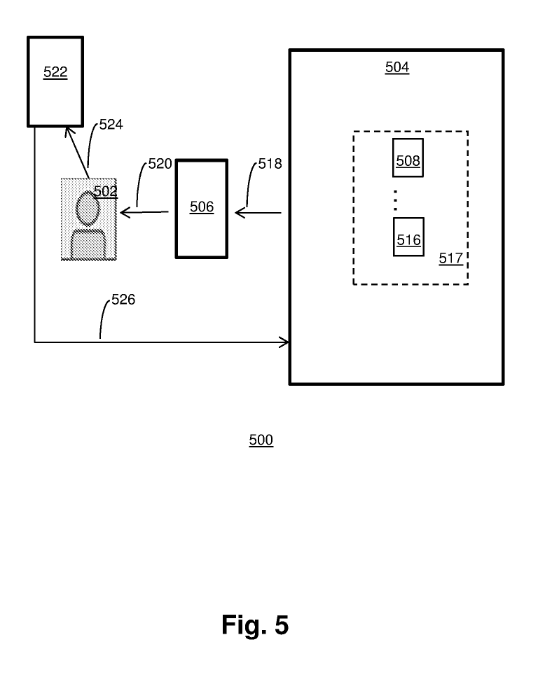

FIG. 5 shows an exemplary system 500 for dynamically optimizing a course of learning. The system 500 comprises at least one target learner 502 and is configured to create a learning environment profile 517 of target learners 502 of a target course provided by an organization 504 as described in step 102 of FIG. 1. The learning environment profile 517 comprises one or more sets of data collected from any one or more of the target learners, the organization 504 and one or more teachers 206 of the target course.

In the system 500, a plurality of parameters are established for optimizing a cerebral course of learning for the target learners 502 in response to the one or more sets of data. In the present embodiment, nine sets of parameters 508, 509, 510, 511, 512, 513, 514, 515 and 516 as described above are established. For the simplicity of understanding, only 508 and 516 are expressly shown in FIG. 5. It is understandable to the skilled person that similar sets of parameters in connection to the learning environment may also been included.

In the system 500, the course of learning is optimized 518 in accordance with the plurality of parameters 508 to 516. The optimized course of learning is then presented 520 to one or more of the target learners 502. This present embodiment of the optimized course of learning may involve inputs from one or more teachers 506.

In the system 500, the cerebral learning of the one or more target learners 502 of the optimized course of learning is then measured 524 to arrive at an effectiveness feedback (EFK) 522 of the plurality of parameters 508 to 516.

If the EFK 522 falls below a predetermined threshold, one or more of the plurality of parameters will be refined 526 to dynamically optimize the course of learning.

It should be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. A method for dynamically optimizing a course of learning, the method comprising:
creating a learning environment profile of target learners of a target course, wherein the learning environment profile comprises one or more sets of data collected from the target learners and one or more teachers of the target course;
establishing a plurality of parameters for optimizing cerebral learning for the target learners in response to the one or more sets of data;
optimizing the course of learning in accordance with the plurality of parameters;
presenting the optimized course of learning to one or more of the target learners;
measuring the cerebral learning of the one or more target learners of the optimized course of learning to arrive at an effectiveness feedback (EFK) of the plurality of parameters; and
refining one or more of the plurality of parameters to dynamically optimize the course of learning when the effectiveness feedback falls below a predetermined threshold.

2. The method in accordance with claim 1, wherein the plurality of parameters comprise one or more of the following: goal of the target course, self-organization strength, adaptive practice possibility, form and/or possibility of recalling learned knowledge, possibility of spacing the learning, mixing the topics of study, possibility of learning with friends, application of the knowledge learned in the target course beyond the target course, and connecting learned knowledge with present or future situations.

3. The method in accordance with claim 1 or 2, wherein the one or more sets of data collected from the target learners and the one or more teachers of the target course comprise one or more profiles of any one or more of: the target learners, objectives, the one or more teachers of the target course, and tools.

4. The method in accordance with any of claims 1 to 3, wherein the one or more sets of data further comprise one or more profiles of an organization that provides the target course.

5. The method in accordance with any of claims 1 to 4, wherein optimizing the course of learning in accordance with the plurality of parameters comprises selecting the course of learning from a plurality of predetermined courses of learning.

6. The method in accordance with claim 3, wherein the one or more profiles of the target learners comprise demographic information including age, prior education background, prior background in the target course, amount of time devoted to learning the target course, profile of time devoted to learning the target course, physical location of the target learners, learning style of the target learners, motivation level of the target learners, and learning objective of the target learners.

7. The method in accordance with claim 3, wherein the one or more profiles of the objectives comprise information including objective of the target course and/or expected capability that the target learner will gain from the target course.

8. The method in accordance with claim 4, wherein the one or more profiles of the organization comprise information including the organization's objective for the target course, the resource available to support the course such as: time, technology, financial support and people and the organization's criteria for assessing the success of the target course.

9. The method in accordance with claim 3, wherein the one or more profiles of the one or more teachers of the target course comprise demographic information including the one or more teachers' objectives, teaching time, background and/or formal instruction in teaching, extent of knowledge of the target course, effectiveness as a facilitator, and possibility of physical presence at the target course.

10. The method in accordance with claim 3, wherein the one or more profiles of the tools comprise information including available tools, technology devices, internet access and/or physical spaces to support learning.

11. A system for dynamically optimizing a course of learning, wherein the system comprises at least one target learner and is configured to:
create a learning environment profile of target learners of a target course provided by an organization, wherein the learning environment profile comprises one or more sets of data collected from the target learners, the organization and one or more teachers of the target course;
establish a plurality of parameters for optimizing a cerebral course of learning for the target learners in response to the one or more sets of data;
optimize the course of learning in accordance with the plurality of parameters;
present the optimized course of learning to one or more of the target learners;
measure the cerebral learning of the one or more target learners of the optimized course of learning to arrive at an effectiveness feedback (EFC) of the plurality of parameters; and
refine one or more of the plurality of parameters to dynamically optimize the course of learning when the effectiveness feedback falls below a predetermined threshold.

12. The system in accordance with claim 11, wherein optimizing the course of learning in accordance with the plurality of parameters comprises selecting the course of learning from a plurality of predetermined courses of learning.

13. The system in accordance with claim 11 or 12, wherein the plurality of parameters comprise one or more of the following: goal of the target course, self-organization strength, adaptive practice possibility, form and/or possibility of recalling learned knowledge, possibility of spacing the learning, mixing the topics of study, possibility of learning with friends, application of the knowledge learned in the target course beyond the target course and connecting learned knowledge with relevant present or future situations.

14. The system in accordance with any of claims 11 to 13, wherein the one or more sets of data collected from the target learner, the organization and one or more teachers of the target course comprise one or more profiles of any one or more of the target learners, objectives, the organization, the one or more teachers of the target course and tools.

15. The system in accordance with claim 14, wherein the one or more profiles of the target learner comprise demographic information including age, prior education background, prior background in the target course, amount of time devoted to learning the target course, profile of time devoted to learning the target course, physical location of the target learners, learning style of the target learners, motivation level of the target learners, and/or learning objective of the target learners.

16. The system in accordance with claim 14 or 15, wherein the one or more profiles of the objectives comprise information including objective of the target course and/or expected capability that the target learner will gain from the target course.

17. The system in accordance with any of claims 14 to 16, wherein the one or more profiles of the organization comprise information including the organization's objective for the target course, the resources available to support the course, such as time, technology, financial support and people, and the organization's criteria for assessing the success of the target course.

18. The system in accordance with any of claims 14 to 17, wherein the one or more profiles of the one or more teachers of the target course comprise demographic information including the one or more teachers' objectives, teaching time, background and/or formal instruction in teaching, extent of knowledge of the target course, effectiveness as a facilitator, and possibility of physical presence at the target course.

19. The system in accordance with any of claims 14 to 18, wherein the one or more profiles of the tools comprise information including available tools, technology devices, internet access and/or physical spaces to support learning.
